(19) United States
(12) Patent Application Publication
(10) Pub. No.: US 2026/0368962 A1
(43) Pub. Date: Nov. 19, 2026

(54) SYSTEMS AND METHODS FOR GLYPH MODIFICATION

(71) Applicant: ADOBE INC., San Jose, CA (US)

(72) Inventors: Nippun Sharma, Delhi (IN); Kshitiz Kaushik, New Delhi (IN); Vineet Batra, Delhi (IN)

(21) Appl. No.: 19/205,225

(22) Filed: May 12, 2025

(51) Int. Cl. G06T 11/60

(52) U.S. Cl. CPC G06T 11/60

(57) ABSTRACT

A method, apparatus, non-transitory computer readable medium, and system for image generation includes obtaining a glyph image and a guidance prompt, where the glyph image depicts a target structure and the guidance prompt indicates a target semantic concept, generating a latent code based on the glyph image and the guidance prompt using a perceptual loss, where the latent code represents the target structure and the target semantic concept, and generating a synthetic image based on the latent code, where the synthetic image depicts the target structure and the target semantic concept.

### BACKGROUND

The following relates generally to image generation, and more specifically to glyph modification. Machine learning models such as diffusion models may be trained to generate an image depicting content described by inputs such as text and images. Image generation machine learning techniques may be applied to modify a glyph image, or an image depicting a representation of a character. However, in some cases images that depict glyphs or characters do not accurately depict these symbols. Therefore, there is a need in the art for improved systems and methods for generating images that depict glyphs and characters.

### SUMMARY

Systems and methods are described for glyph modification. In one example, an image generation system uses an image generation model to generate a latent representation of a glyph image in a latent space of the image generation model and iteratively optimizes the latent representation according to a guidance input, such as a text prompt or an image prompt, using a loss function including a denoising loss function and a perceptual loss function. The image generation model generates a synthetic image using the optimized latent representation.

The glyph image depicts a structure of a glyph, and the guidance input depicts or describes a semantic concept. Because the synthetic image is generated based on the optimized latent representation, the synthetic image accurately depicts the structure of the glyph according to the semantic concept of the guidance input.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of an image generation system according to aspects of the present disclosure.

FIG. 2 shows an example of a method for generating a synthetic image according to aspects of the present disclosure.

FIG. 3 shows an example of synthetic images generated according to an image guidance according to aspects of the present disclosure.

FIG. 4 shows an example of synthetic images generated according to a text guidance according to aspects of the present disclosure.

FIG. 5 shows an example of an image generation system for generating a synthetic image according to aspects of the present disclosure.

FIG. 6 shows an example of the effects of losses on a synthetic image according to aspects of the present disclosure.

FIG. 7 shows an example of the effects of weighting a perceptual loss according to aspects of the present disclosure.

FIG. 8 shows an example of the effects of time step sampling according to aspects of the present disclosure.

FIG. 9 shows an example of a guided diffusion model according to aspects of the present disclosure.

FIG. 10 shows an example of a U-Net according to aspects of the present disclosure.

FIG. 11 shows an example of a diffusion transformer architecture according to aspects of the present disclosure.

FIG. 12 shows an example of a method for generating a synthetic image depicting a target structure and a target semantic concept using an optimized latent code according to aspects of the present disclosure.

FIG. 13 shows an example of a method for generating a synthetic image based on a latent representation of a glyph image according to aspects of the present disclosure.

FIG. 14 shows an example of a diffusion process according to aspects of the present disclosure.

FIG. 15 shows an example of an algorithm for generating a synthetic image according to aspects of the present disclosure.

FIG. 16 shows an example of a flow diagram depicting an algorithm as a step-by-step procedure for training a machine learning model according to aspects of the present disclosure.

FIG. 17 shows an example of a method for training a diffusion model according to aspects of the present disclosure.

FIG. 18 shows an example of a computing device according to aspects of the present disclosure.

FIG. 19 shows an example of an image generation apparatus according to aspects of the present disclosure.

### DETAILED DESCRIPTION

### Overview

Text and fonts are pivotal elements in digital design, capturing the audience's attention and conveying the intended message. Designers often need to manually tweak selected glyphs, also known as “lettering,” to ensure they match the style and semantics of the artwork. This meticulous process is both time-consuming and challenging, requiring a high level of skill and precision.

While generative machine learning has revolutionized various aspects of digital artwork, streamlining workflows and enhancing creativity, the text domain remains largely untouched, primarily due to the poor performance of large diffusion models on glyph images. Large diffusion models struggle to modify text in a way that preserves a readability of the text while aligning the text with a desired aesthetic and semantic context. Accordingly, existing processes for modifying glyphs require the use of specifically trained models, which are computationally expensive and perform poorly on input data that the models have not been trained on, and introduce unintended distortions to a structure of the glyph.

Accordingly, systems and methods are described for glyph modification. In one example, an image generation system uses an image generation model to generate a latent representation of a glyph image in a latent space of the image generation model and iteratively optimizes the latent representation according to a guidance input, such as a text prompt or an image prompt, using a loss function including a denoising loss function and a perceptual loss function. The image generation model generates a synthetic image using the optimized latent representation.

The glyph image depicts a structure of a glyph, and the guidance input depicts or describes a semantic concept. Because the synthetic image is generated based on the optimized latent representation, the synthetic image accurately depicts the structure of the glyph according to the semantic concept of the guidance input.

### TERMINOLOGY EXAMPLES

A “glyph image” refers to an image depicting one or more glyphs. A glyph is a representation of a structure or shape, such as a character, or a unit of text. A glyph image may be provided as a bitmap (an array of pixels). A glyph may be depicted according to a particular typeface. A glyph may depict a target structure, or a structure of the glyph (e.g., an arrangement of pixels to depict a glyph according to a typeface).

A “guidance prompt” is a prompt provided in a text modality (a text prompt), an image modality (an image prompt), or another modality, such as video or audio. A guidance prompt depicts or describes a target semantic concept, or a “meaning” that may be depicted as a visual characteristic of an image.

A “latent code” or a “latent representation” refers to an abstract, compressed representation of data. A latent code or a latent representation is an encoding of data from an original space into a lower-dimensional space (a “latent space”) that captures essential features or patterns of the data while omitting irrelevant details. In some embodiments, a latent code comprises a latent representation and noise.

An “encoding” or “embedding” is a representation of an object in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar and thus “closer” to each other, thereby allowing a similarity between different objects corresponding to different embeddings to be readily determined.

An “embedding space” (or a “vector space”) refers to a mathematical set having embeddings (or vectors) as components and is characterized by a dimension specifying a number of independent directions in the embedding space.

A “loss function” is a mathematical function used in machine learning and optimization that quantifies how well or poorly a model's predictions align with true values, or “ground-truth” values. A loss function measures an error or discrepancy between a predicted output of a model and the actual output (the target or correct label).

A “synthetic image” refers to an image generated by the machine learning model. A synthetic image may be a color image or a black and white image. An “image generation model” is a machine learning model that is trained to generate an image based on a latent representation. In some embodiments, the image generation model is a diffusion model.

An example of the present disclosure is used in an image generation context. In the example, a user provides a glyph image depicting a glyph of the letter “S” and a text guidance prompt “a slithering snake” to the image generation system. The image generation system uses an image generation model to generate a latent code based on the glyph image and optimizes the latent code in an iterative series of time steps based on the guidance prompt and the initial latent code. The image generation system uses the image generation model to generate a synthetic image based on the optimized latent code. The synthetic image depicts the structure of the S stylized according to the semantic concept of a slithering snake (e.g., the synthetic image depicts an S-shaped snake, or an S having snake-like visual features).

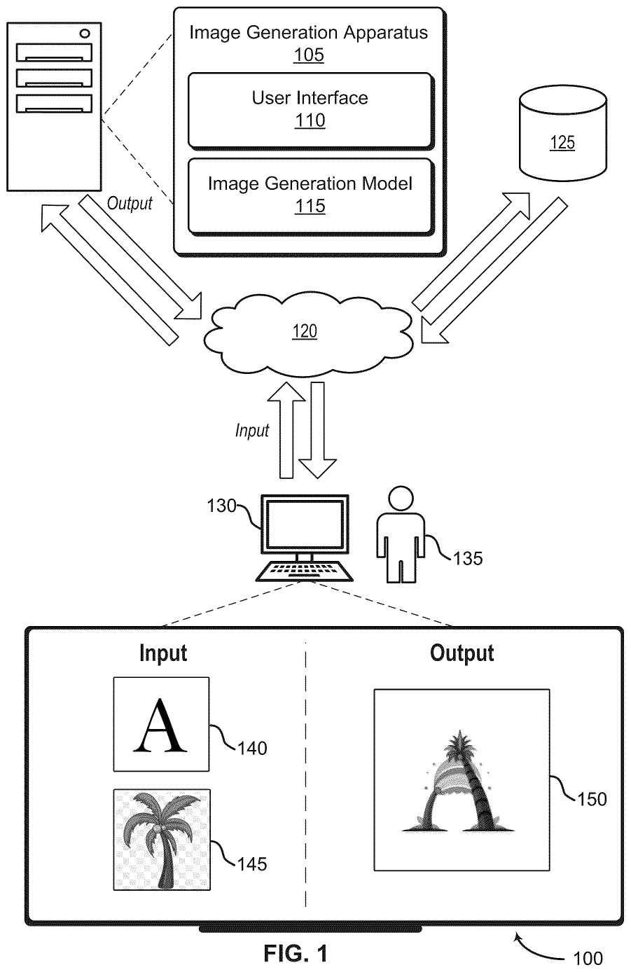

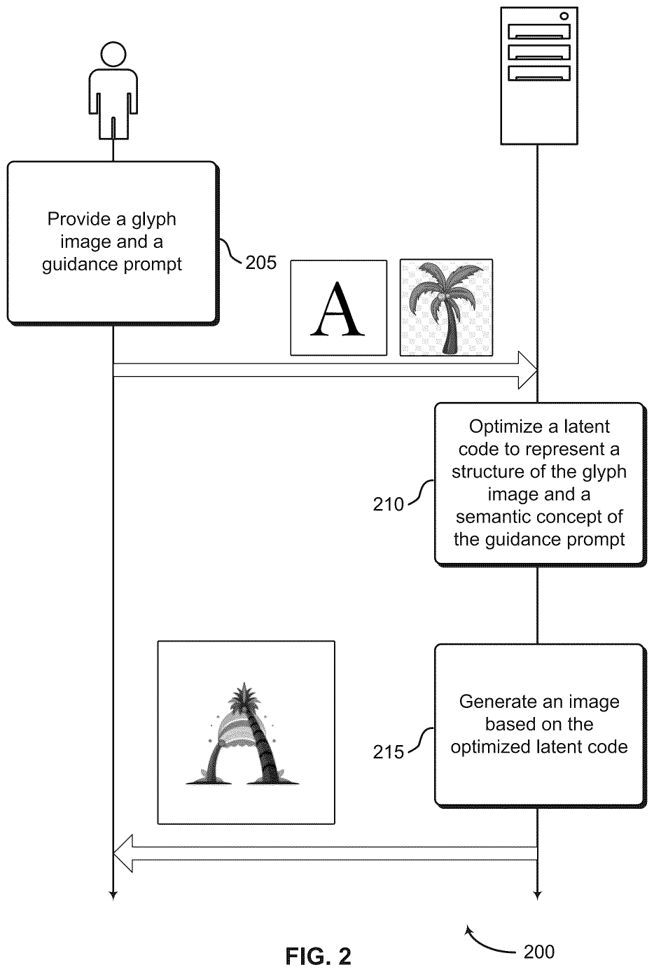

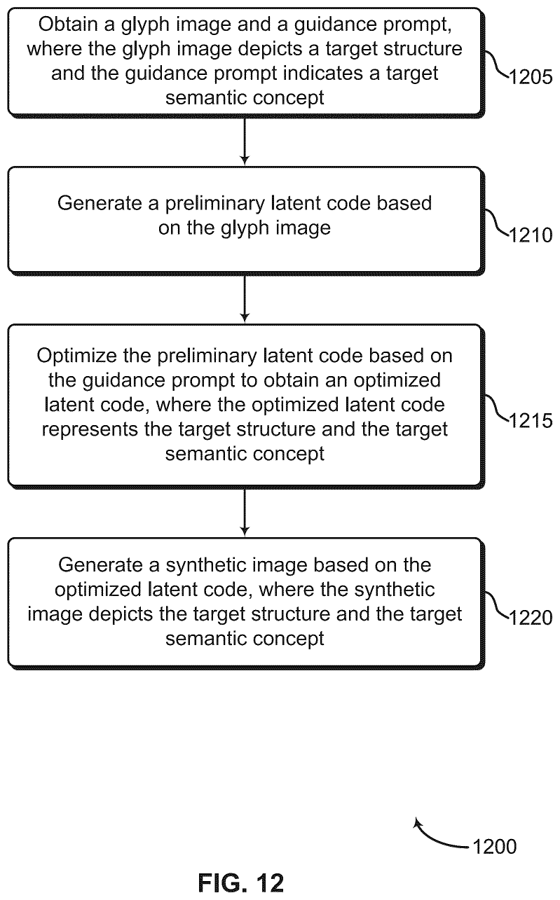

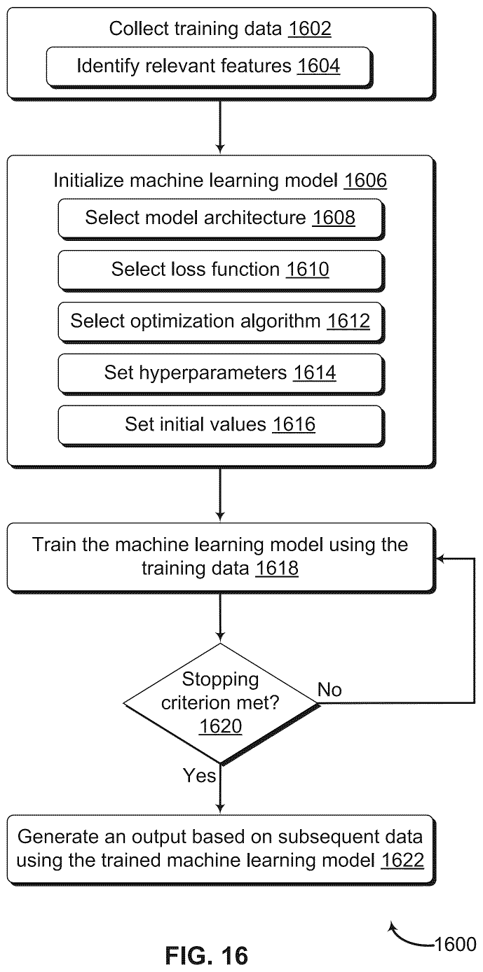

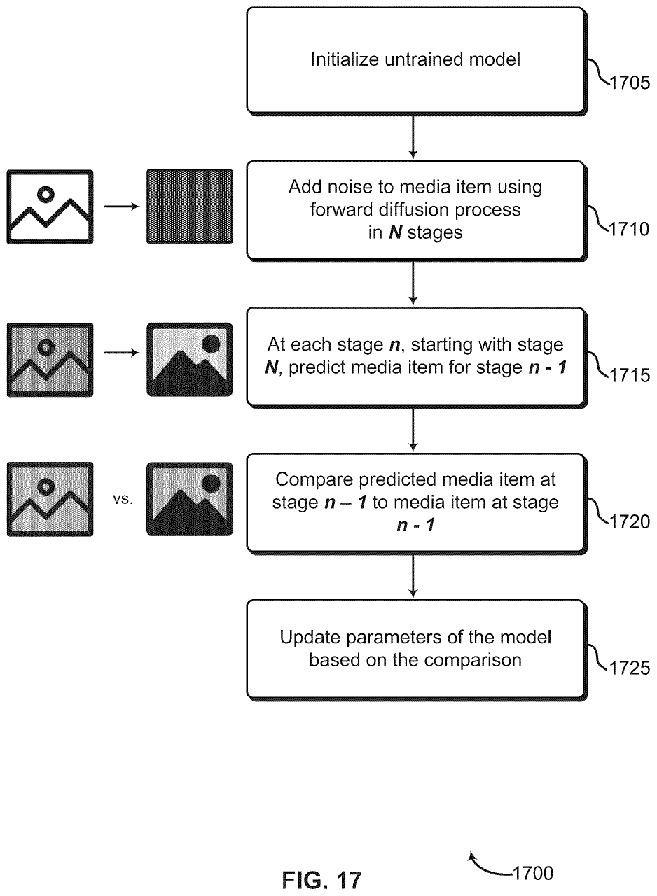

Further examples of the present disclosure in an image generation context are provided with reference to FIGS. 1-2. Details regarding the architecture of the image generation system are provided with reference to FIGS. 1, 3-11, and 18-19. Examples of a process for generating a synthetic image depicting a modified glyph are provided with reference to FIGS. 12-15. Examples of a process for training the image generation model are provided with reference to FIGS. 16-17.

Embodiments of the present disclosure improve upon conventional image generation systems by making a glyph modification process more accurate. For example, some embodiments achieve this accuracy by optimizing a latent code according to a denoising loss and a perceptual loss. The combination of the denoising loss and the perceptual loss allows the optimized latent code to accurately represent a target structure of a glyph image and a target semantic concept of a guidance prompt.

A conventional image generation system uses a score distillation sampling loss to optimize a latent code generated based on an input glyph image according to text guidance. However, this comparative optimized latent code results in a comparative synthetic image depicting a glyph having distorted geometry (e.g., unintentional jagged edges), and the comparative synthetic image is only generated in black and white. By contrast, the combination of the denoising loss and the perceptual loss allows embodiments of the present disclosure to generate a synthetic image, based on text or image guidance, depicting a glyph having accurate geometry, in color or in black and white.

Furthermore, some embodiments of the present disclosure provide a weighting parameter for controlling a relative weight of the perceptual loss in determining the optimized latent code. This weighting parameter provides for efficient and accurate user control of a detail level of the synthetic image, which other conventional image generation systems lack.

Embodiments of the present disclosure improve upon conventional image generation systems by making a glyph modification process more efficient. For example, some embodiments achieve this efficiency by optimizing a preliminary latent code according to a denoising loss and a perceptual loss. Optimizing the preliminary latent code at inference time allows a task-specific training process to be avoided, thereby allowing any off-the-shelf image generation model that is trained to obtain a latent code in a latent space, such as a diffusion model, to be used. By contrast, some conventional image generation systems rely on training an image generation model to perform a glyph modification task, which is computationally expensive and inefficient. Furthermore, because the glyph modification process does not rely on a specific glyph modification training task, the glyph modification process is capable of generating accurate synthetic images for any input glyph image and guidance prompt.

### Image Generation System

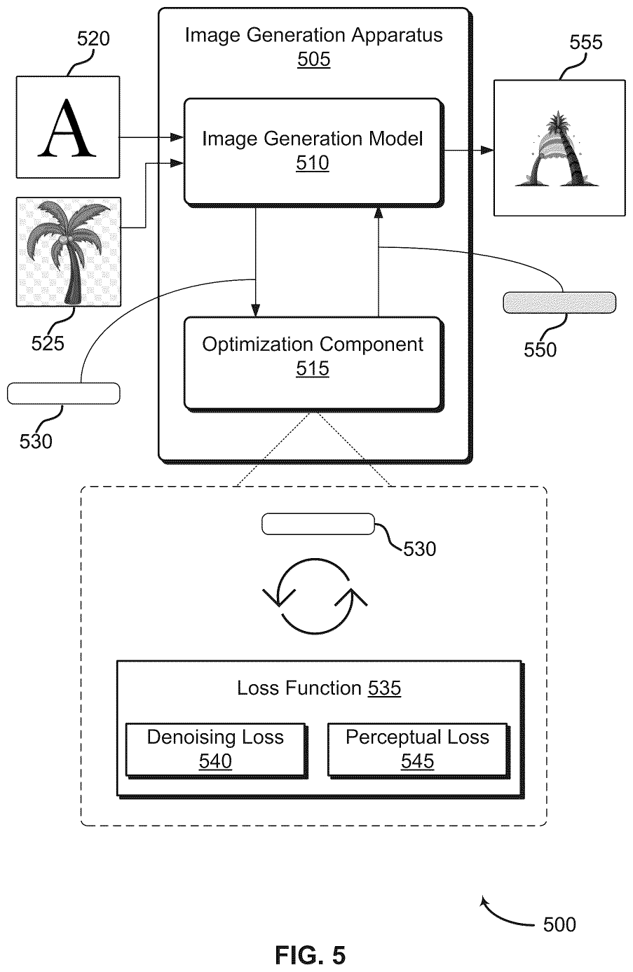

FIG. 1 shows an example of an image generation system 100 according to aspects of the present disclosure. The example shown includes image generation system 100, user device 130, user 135, glyph image 140, guidance prompt 145, and synthetic image 150. Image generation system 100 is an example of, or includes aspects of, the corresponding element described with reference to FIG. 5. In one aspect, image generation system 100 includes image generation apparatus 105, cloud 120, and database 125. In one aspect, image generation apparatus 105 includes user interface 110 and image generation model 115.

Referring to FIG. 1, a user (e.g., user 135) provides a glyph image (e.g., glyph image 140) and a guidance prompt (e.g., guidance prompt 145) to image generation apparatus 105 via user interface 110 displayed on a user device (e.g., user device 130) by image generation apparatus 105. Glyph image 140 depicts a target structure of an “A” glyph, and guidance prompt 145 is a color image depicting a target semantic concept of a palm tree. Image generation model 115 generates a color output image (e.g., synthetic image 150) depicting the target structure and the target semantic concept based on a latent representation of the glyph image that is optimized according to the guidance prompt as described with reference to FIG. 5.

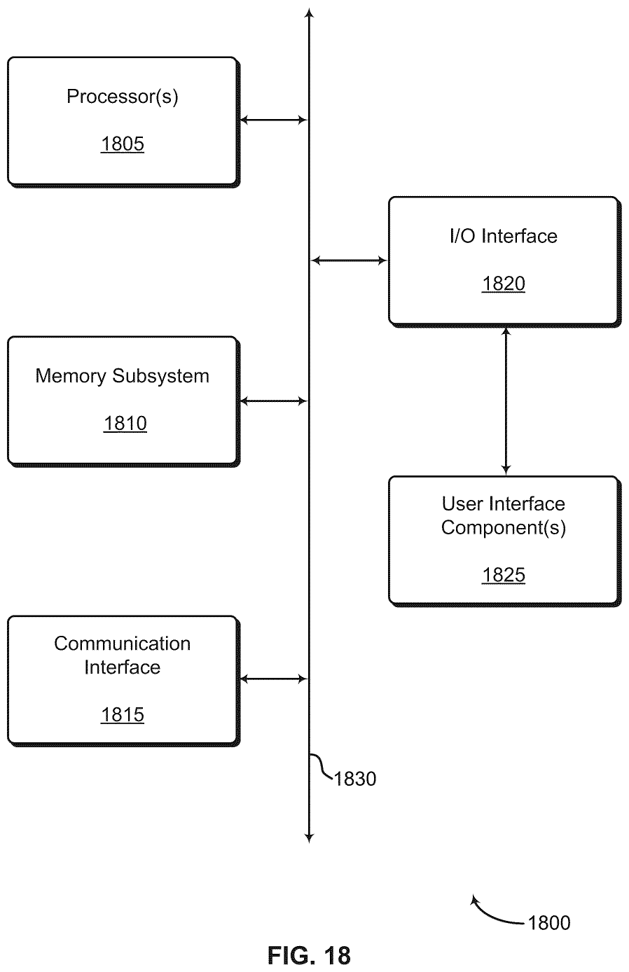

Image generation apparatus 105 is an example of, or includes aspects of, the corresponding element described with reference to FIGS. 5, 18, and 19. According to some aspects, image generation apparatus 105 includes a computer-implemented network. In some embodiments, the computer-implemented network includes image generation model 115. Image generation apparatus 105 may also include one or more processors, a memory subsystem, a communication interface, an I/O interface, one or more user interface components, and a bus as described with reference to FIG. 18. Additionally, image generation apparatus 105 may communicate with the user device and database 125 via cloud 120.

According to some aspects, image generation apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

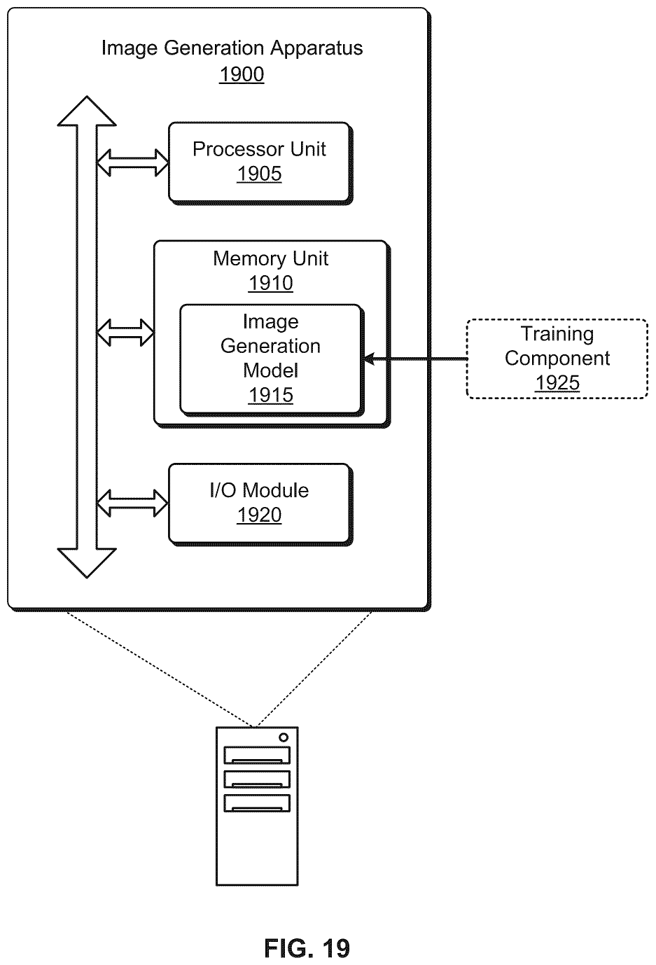

User interface 110 allows information to be communicated between the user and image generation apparatus 105. According to some aspects, user interface 110 comprises a text interface, a graphical user interface, or a combination thereof. According to some aspects, user interface 110 comprises software stored in a memory unit of image generation apparatus 105 (such as the memory unit 1910 described with reference to FIG. 19).

Image generation model 115 is an example of, or includes aspects of, the corresponding element described with reference to FIGS. 5, 9-11, and 19. According to some aspects, image generation model 115 comprises machine learning parameters stored in the memory unit of image generation apparatus 105. According to some aspects, image generation model 115 comprises an artificial neural network (ANN) that is trained as described with reference to FIGS. 16-17 and 19 to generate a synthetic image (e.g., a diffusion model).

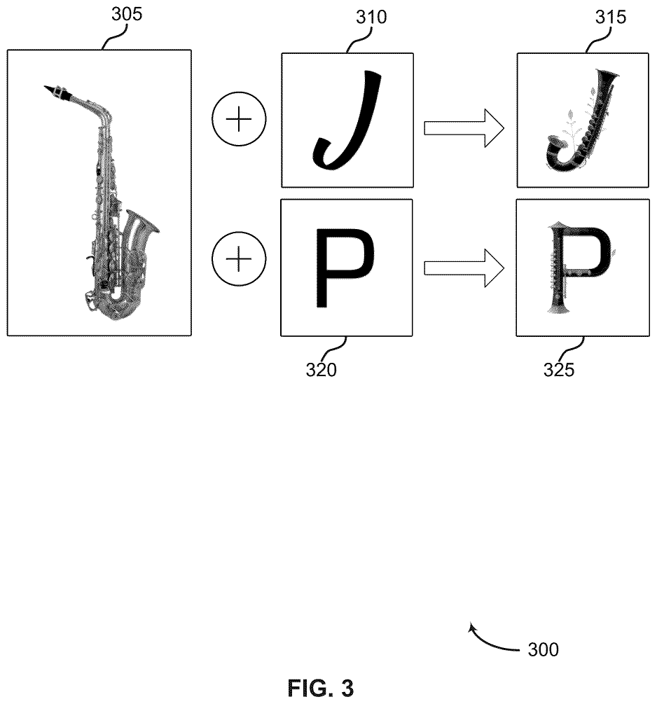

Further detail regarding the architecture of an image generation system is provided with reference to FIGS. 3-11 and 18-19. Further detail regarding a processes for generating a synthetic image is provided with reference to FIGS. 2 and 12-15. Further detail regarding a process for training image generation model 115 is provided with reference to FIGS. 16-17 and 19.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if the server has a direct or close connection to a user. In some examples, cloud 120 is limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between image generation apparatus 105, database 125, and the user device.

Database 125 is an organized collection of data. In an example, database 125 stores data in a specified format known as a schema. According to some aspects, database 125 is structured as a single database, a distributed database, multiple distributed databases, or an emergency backup database. Data storage and processing in database 125 is manageable by a database controller, which can be operated by a user or automatically without interaction from the user. According to some aspects, database 125 is included in image generation apparatus 105. According to some aspects, database 125 is external to image generation apparatus 105 and communicates with image generation apparatus 105 via cloud 120.

According to some aspects, user device 130 is a personal computer, laptop computer, mainframe computer, palmtop computer, personal assistant, mobile device, or any other suitable processing apparatus. In some examples, user device 130 includes software that displays user interface 110 provided by image generation apparatus 105.

According to some aspects, a user device user interface enables a user to interact with user device 130. In some embodiments, the user device user interface includes an audio device, such as an external speaker system, an external display device such as a display screen, or an input device (e.g., a remote-control device interfaced with the user interface directly or through an I/O controller module). In some cases, the user device user interface is a graphical user interface.

Glyph image 140 is an example of, or includes aspects of, the corresponding element described with reference to FIGS. 3-5 and 7. Guidance prompt 145 is an example of, or includes aspects of, the corresponding element described with reference to FIGS. 3-5. Synthetic image 150 is an example of, or includes aspects of, the corresponding element described with reference to FIGS. 3-8.

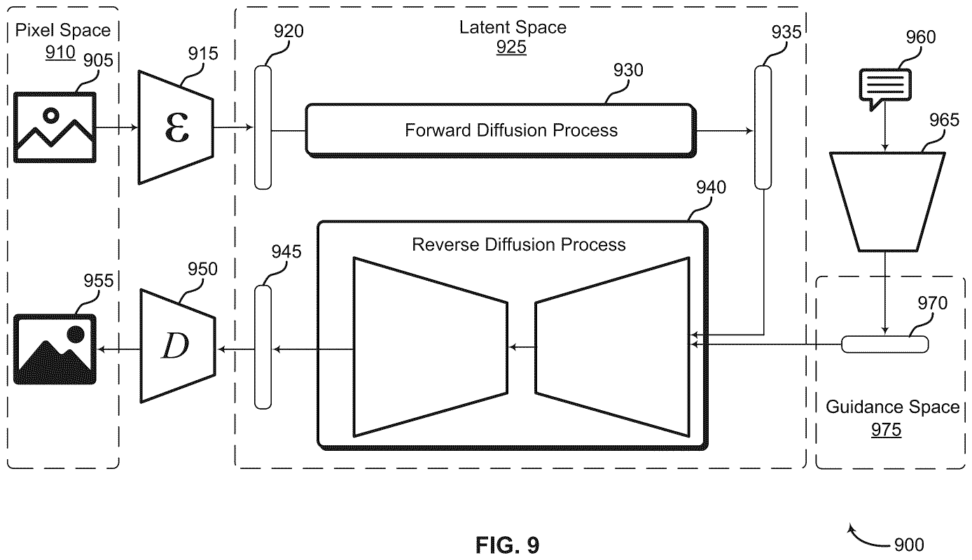

FIG. 2 shows an example of a method 200 for generating a synthetic image according to aspects of the present disclosure. In some examples, method 200 describes an operation of the image generation model 1915 described with reference to FIG. 19 such as an application of the guided diffusion model 900 described with reference to FIG. 9. In some examples, these operations are performed by a system including a processor executing a set of codes to control functional elements of an apparatus such as the image generation model described in FIG. 9.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 2, a user provides a glyph image and a guidance prompt to an image generation apparatus. In the example of FIG. 2, the glyph image depicts a target structure of an “A” glyph, and the guidance prompt is an image depicting a target semantic concept of a palm tree. The image generation model of the image generation apparatus generates an output image depicting the target structure and the target semantic concept (e.g., an A stylized to have characteristics of a palm tree) based on a latent representation of the glyph image that is optimized according to the guidance prompt as described with reference to FIG. 5.

At operation 205, a user provides a glyph image and a guidance prompt. In some cases, the operations of this step refer to, or may be performed by, a user as described with reference to FIG. 1.

At operation 210, the system optimizes a latent code to represent a structure of the glyph image and a semantic concept of the guidance prompt. In some cases, the operations of this step refer to, or may be performed by, an image generation apparatus as described with reference to FIGS. 1, 5, 18, and 19. In an example, the image generation model generates a latent code in a latent space based on the glyph image as described with reference to FIG. 5, and the latent code is optimized according to the guidance prompt as described with reference to FIG. 5.

At operation 215, the system generates an image based on the optimized latent code. In some cases, the operations of this step refer to, or may be performed by, an image generation apparatus as described with reference to FIGS. 1, 5, 18, and 19. In an example, the image generation model decodes the optimized latent code from the latent space to a pixel space to generate the synthetic image.

FIG. 3 shows an example 300 of synthetic images generated according to an image guidance according to aspects of the present disclosure. The example shown includes guidance prompt 305, first glyph image 310, first synthetic image 315, second glyph image 320, and second synthetic image 325.

Referring to FIG. 3, a synthetic image (e.g., first synthetic image 315 or second synthetic image 325) may be generated using an image generation system as described with reference to FIG. 5 based on a guidance prompt (e.g., guidance prompt 305) and a glyph image (e.g., first glyph image 310 or second glyph image 320). In the example of FIG. 3, guidance prompt 305 is an image depicting a saxophone and first glyph image 310 depicts the letter “J”. First synthetic image 315 is generated based on guidance prompt 305 and first glyph image 310, and depicts the structure of the letter “J” with the semantic concept of the saxophone depicted in guidance prompt 305. Likewise, second synthetic image 325 is generated based on guidance prompt 305 and second glyph image 320 and depicts the structure of the letter “P” depicted in second glyph image 320 with the semantic concept of the saxophone depicted in guidance prompt 305.

Guidance prompt 305 is an example of, or includes aspects of, the corresponding element described with reference to FIGS. 1 and 4-5. First glyph image 310 and second glyph image 320 are examples of, or include aspects of, the corresponding elements described with reference to FIGS. 1, 4-5, and 7. First synthetic image 315 and second synthetic image 325 are examples of, or include aspects of, the corresponding elements described with reference to FIGS. 1 and 4-8.

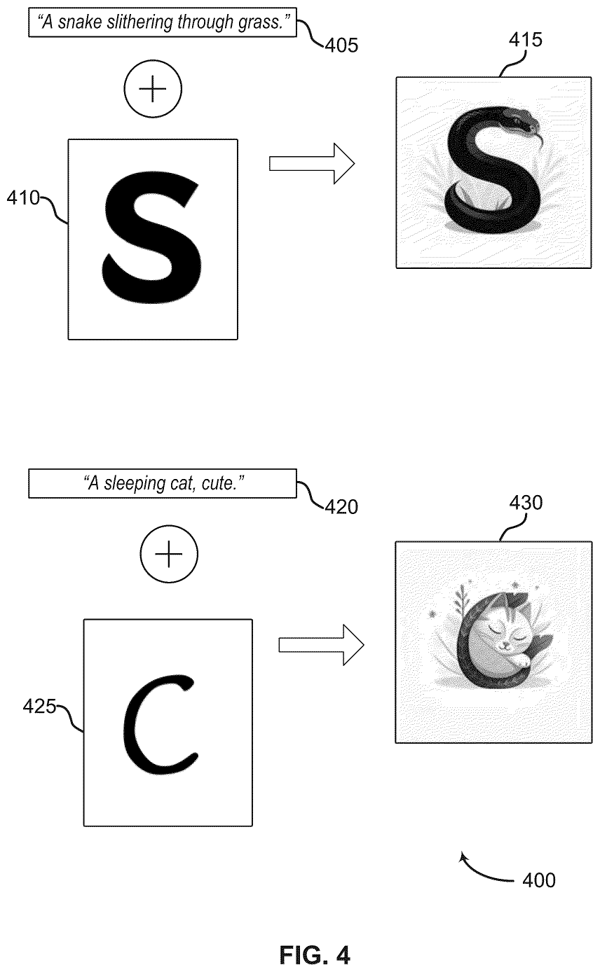

FIG. 4 shows an example 400 of synthetic images generated according to a text guidance according to aspects of the present disclosure. The example shown includes first guidance prompt 405, first glyph image 410, first synthetic image 415, second guidance prompt 420, second glyph image 425, and second synthetic image 430.

Referring to FIG. 4, a synthetic image (e.g., first synthetic image 415 or second synthetic image 430) may be generated using an image generation system as described with reference to FIG. 5 based on a guidance prompt (e.g., first guidance prompt 405 or second guidance prompt 420) and a glyph image (e.g., first glyph image 410 or second glyph image 425). In the example of FIG. 4, first guidance prompt 405 is a text prompt “A snake slithering through grass” and first glyph image 410 depicts the letter “S”. First synthetic image 415 is generated based on first guidance prompt 405 and first glyph image 410 and depicts the structure of the letter “S” with the semantic concept of the snake slithering through grass described by first guidance prompt 405. Likewise, second synthetic image 430 is generated based on second guidance prompt 420 and second glyph image 425 and depicts the structure of the letter “C” depicted in second glyph image 425 with the semantic concept of “a sleeping cat, cute” described by second guidance prompt 420.

First guidance prompt 405 and second guidance prompt 420 are examples of, or include aspects of, the corresponding elements described with reference to FIGS. 1, 3, and 5. First glyph image 410 and second glyph image 425 are examples of, or include aspects of, the corresponding elements described with reference to FIGS. 1, 3, 5, and 7. First synthetic image 415 and second synthetic image 430 are examples of, or include aspects of, the corresponding elements described with reference to FIGS. 1, 3, and 5-8.

FIG. 5 shows an example of an image generation system 500 for generating a synthetic image 555 according to aspects of the present disclosure. The example shown includes image generation system 500, glyph image 520, guidance prompt 525, latent code 530, loss function 535, optimized latent code 550, and synthetic image 555. In one aspect, image generation system 500 includes image generation apparatus 505. In one aspect, image generation apparatus 505 includes image generation model 510 and optimization component 515. In one aspect, loss function 535 includes denoising loss 540 and perceptual loss 545.

Referring to FIG. 5, image generation system 500 iteratively optimizes a latent code (e.g., latent code 530) generated based on a glyph image (e.g., glyph image 520) in a latent space of image generation model 510 that captures various spatial relationships within the glyph image, thereby obtaining an optimized latent code (e.g., optimized latent code 550) that can be decoded from the latent space into a pixel space to generate a synthetic image (e.g., synthetic image 555). The synthetic image depicts the structure of the glyph image (e.g., a shape of an alphabetical letter) and a semantic concept of a guidance prompt (e.g., guidance prompt 525), such as a visual characteristic of the guidance prompt.

In an example, image generation model 510 users an encoder of a variational autoencoder (VAE) to encode the glyph image from the pixel space to the latent space to obtain a latent representation. A VAE is a type of generative model that learns to encode input data into a compressed latent space and then decode the compressed data back into the original form. Unlike a traditional autoencoder, which simply compresses and reconstructs data, a VAE imposes a probabilistic structure on the latent space. Instead of mapping an input to a single point in the latent space, the VAE maps the input to a distribution, typically a Gaussian defined by a mean and a standard deviation.

During training, the VAE learns to approximate the distribution so that samples drawn from the distribution can be decoded into data that resembles the original inputs. The encoder of the VAE estimates the parameters of the latent distribution for a given input, and a decoder of the VAE reconstructs the data from samples drawn from the distribution. To make the sampling step differentiable, VAEs use a technique called the reparameterization trick, which allows gradients to pass through the sampling process during backpropagation.

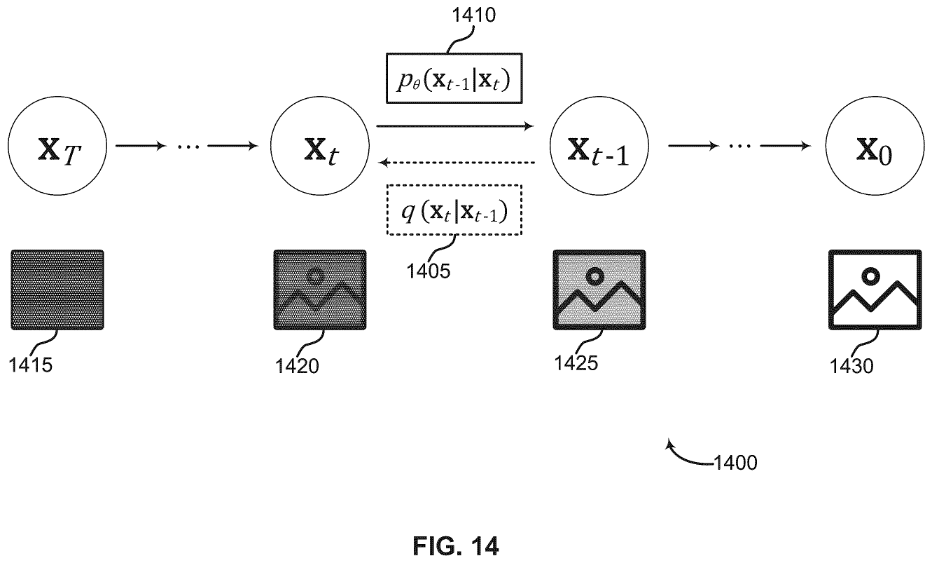

Image generation model 510 adds noise to the latent representation using a forward diffusion process as described with reference to FIGS. 9 and 14 to obtain a latent code. Image generation model 510 then iteratively predicts the noise that was added to the latent representation to obtain the latent code. In some embodiments, instead of iteratively removing predicted noise at each time step t of a reverse diffusion process (such as the reverse diffusion process described with reference to FIGS. 9 and 14), the image generation model iteratively updates the latent code based on loss function 535, including denoising loss 540 and perceptual loss 545, at time steps t according to an optimization algorithm to obtain an optimized latent code. The final optimized latent code (e.g., optimized latent code 550) is thereby optimized to be semantically aligned with a guidance criterion (e.g., guidance prompt 525).

In particular, in some embodiments, denoising loss 540 is a Score Distillation Sampling (SDS) loss. SDS is a technique used in diffusion models to generate samples by optimizing a loss function. SDS leverages the gradients from a pretrained diffusion model to guide an image generation process. SDS is particularly useful for tasks such as image generation and editing, where SDS can control an optimization process using guidance prompts. According to some aspects, given a pretrained diffusion model ϵ_{φ} (e.g., image generation model 510), optimization component 515 optimizes a latent code zₜ(x) at time step t generated by the pretrained diffusion model ϵ_{φ} using the gradient of the SDS loss [symbol] with respect to parameters θ of ϵ_{φ}:

$${∇}_{θ} {ℒ}_{SDS} = w ( t ) ( {ϵ}_{ϕ}^{s} ( {z}_{t} ( x ) ; y , t ) - ϵ ) \frac{\partial y}{\partial θ} \qquad ( 1 )$$

x is the glyph image, y is an embedding of the guidance prompt in the latent space, (generated by an encoder as described with reference to FIG. 9), ϵ is noise predicted by image generation model 510 to be included in the latent code at time step t, and w(t) is a weighting function. zₜ(x) is shifted toward a denser location in the distribution of real images (noised to time step t and aligned with the criterion y), given by the score

$${ϵ}_{ϕ}^{s} ( {z}_{t} ( x ) ; y , t ) .$$

Eventually, by shifting zₜ(x), the generated noise ϵ is eliminated, thereby adjusting the direction of zₜ(x) back to the domain of clean rendered images and optimizing zₜ(x). The denoising loss thus minimizes a KL divergence between the distributions p(zₜ, y, t) that image generation model 510 has been trained to learn and a family of Gaussian distributions around x.

The denoising loss therefore allows for the generation of high-quality samples in various parameter spaces, such as three-dimensional spaces, where the samples can be mapped back to images differentiably. Additionally, the denoising loss also provides an ability to control the generation process by pairing [symbol] with the perceptual loss. The SDS optimization is performed in the latent space of image generation model 510.

Perceptual loss 545 encourages the optimized latent code to adhere to the structural content of the glyph image. According to some aspects, the perceptual loss comprises a mean squared error (MSE) loss applied on RGB (red, green, and blue) channels of the latent code, or channels of the latent space that correspond to RGB values for the latent code:

$$G ( {z}_{l} ) = \frac{1}{{C}_{l} {H}_{l} {W}_{l}} {z}_{l} {z}_{l}^{T} \qquad ( 2 )$$

$${ℒ}_{MSE} = MSE ( G ( {z}_{l}^{initial} ) , G ( {z}_{l}^{t} ) )$$

zₗ represents a feature map output of an l-th layer of a convolutional neural network (CNN), such as VGG-16, Cₗ represents a number of channels in zₗ, Hₗ comprises a height of zₗ, Wₗ comprises a width of zₗ, G(zₗ) comprises a gram matrix of zₗ, and MSE is the mean squared error function. In other words, in some embodiments, at each time step t, optimization component 515 passes the initial latent code z(x) through a CNN of optimization component 515 to obtain

$$G ( {z}_{l}^{initial} )$$

and likewise passes the current latent code zₜ(x) through the CNN to obtain

$$G ( {z}_{l}^{current} ) .$$

[symbol]

measures a difference between the high-level features of

$${z}_{l}^{initial} and {z}_{l}^{current}$$

extracted from the CNN.

According to some aspects, the perceptual loss comprises a Structural Similarity Index Measure (SSIM) loss [symbol] that compares corresponding patches in an initial latent code and a latent code at time step t of an image (e.g., zᵢₙᵢₜ and zₜ, respectively) to evaluate their similarity and is applied on the non-RGB channels of the latent space, or the remaining channels of the latent space other than the channels that correspond to RGB values:

$${ℒ}_{SSIM} = \frac{1 - SSIM ( {z}_{init} , {z}_{t} )}{2} \qquad ( 3 )$$

In some embodiments, for two inputs x, y representing zᵢₙᵢₜ, zₜ, respectively:

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} \qquad ( 4 )$$

μₓ is the sample mean of x, μ_{y}, is the sample mean of y,

$${σ}_{x}^{2}$$

is the sample variance of x,

$${σ}_{y}^{2}$$

is the sample variance of y, σ_{xy} is the sample covariance of x and y, c₁=(k₁L)², c₂=(k₂L)² are stabilizing variables, and L is a dynamic range of pixel values. The SSIM loss [symbol] is sensitive to human visual perception, ensuring that the generated images retain structural integrity and visual fidelity. The SSIM loss assesses image quality based on luminance, contrast, and structure. According to some aspects, the perceptual loss comprises the mean squared error loss [symbol] the SSIM loss [symbol] , or a combination thereof. In an example, the perceptual loss [symbol] comprises the mean squared error loss [symbol] on the RGB channels of the latent code (e.g., channels 1-3) and the SSIM loss [symbol] on the remaining channels of the latent code (e.g., channels 4-12):

[symbol]

[symbol] indicates that Gaussian noise has been added to the latent representation z. According to some aspects, the loss function 535 therefore comprises a combination of the denoising loss and the perceptual loss:

[symbol]

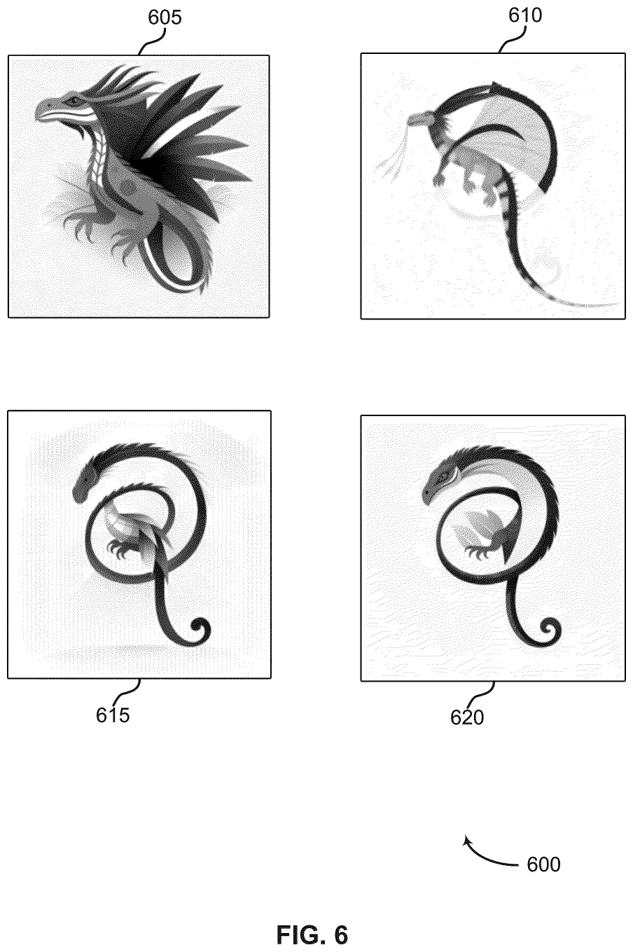

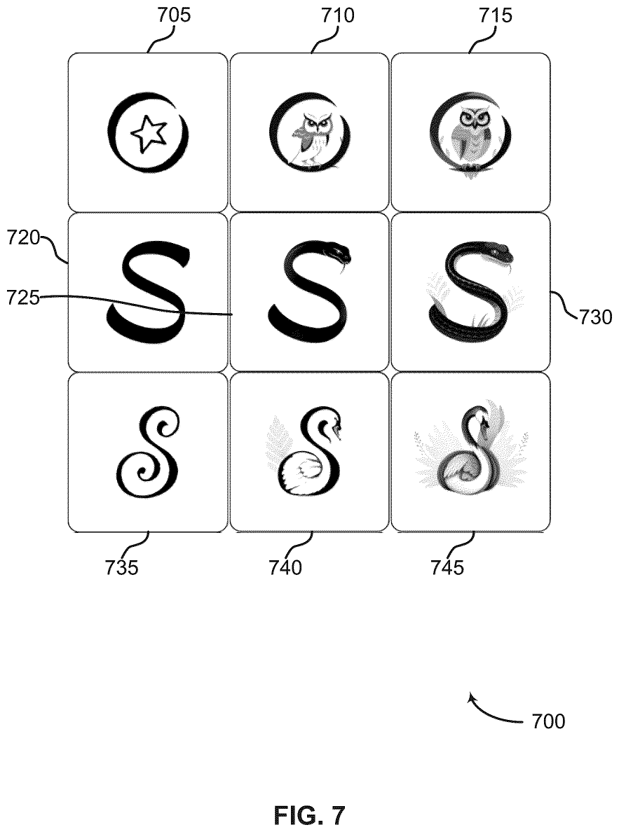

An example of a synthetic image generated based on the loss function [symbol] is described with reference to FIG. 6. λ is a user-controllable weighting parameter for the perceptual loss [symbol] in the loss function [symbol] . A user may provide an input to a user interface element that controls a value of λ. Altering λ thereby allows a user to control a weight of the perceptual loss [symbol] in the loss function [symbol] , and consequently an amount of detail included in the synthetic image. Examples of synthetic images generated according to varying λ parameters are described with reference to FIG. 7.

In equation 5, t~DreamTime+Random. When using a diffusion model to manage an amount of low frequency and high frequency changes, timestep scheduling is crucial. Diffusion models may have difficulty producing optimal images when employing random timesteps, especially for out-of-distribution (OOD) images. This challenge typically arises because random timesteps fail to provide the necessary gradients for effective optimization, leading to suboptimal image generation. In some embodiments, therefore, a latent code is sampled for optimization at t~DreamTime+Random time steps, rather than uniform sampling at each t time step. DreamTime sampling is a time-prioritized sampling method that modulates a time step descent process based on a normalized weight function representing an importance of a diffusion time step t and controls a decreasing speed of the sampling.

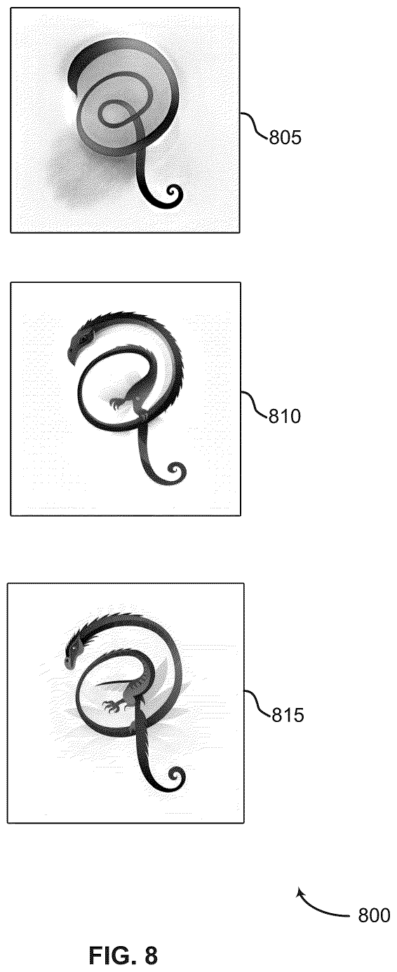

Combining DreamTime sampling with random timesteps mitigates artifacts and incompleteness by breaking an optimization chain, allowing the image generation model to focus on optimizing an in-distribution image. By processing the given image to align with the learned distribution of the image generation model, more coherent and artifact-free results are achieved. Integrating randomness into the sampling process can enhance the performance of the image generation model, particularly for OOD images, by promoting a more balanced and effective optimization process. In some embodiments, an adjustment of DreamTime's hyperparameters can be used to regulate the degree of intricacy and the extent of glyph image modifications that needed to be made. An example of a synthetic image generated based on DreamTime and random time step sampling is described with reference to FIG. 8.

According to some aspects, optimization component 515 optimizes the latent code according to a gradient of the total loss [symbol] with respect to the latent code using an optimization algorithm, such as stochastic gradient descent, Adam, or AdamW:

z←OptimizationAlgorithm(z,∇z [symbol] ) (7)

Image generation model 510 uses a decoder of the VAE to decode the optimized latent code from the latent space to the pixel space to obtain the synthetic image. In some embodiments, image generation apparatus 505 vectorizes the synthetic image to achieve a scalable glyph.

Image generation system 500 is an example of, or includes aspects of, the corresponding element described with reference to FIG. 1. Image generation apparatus 505 is an example of, or includes aspects of, the corresponding element described with reference to FIGS. 1, 18, and 19. Image generation model 510 is an example of, or includes aspects of, the corresponding element described with reference to FIGS. 1, 9-11, and 19.

In some embodiments, optimization component 515 comprises hardware, firmware, or software stored in a memory unit of image generation apparatus 505 (such as the memory unit 1910 described with reference to FIG. 19) and executed by a processor unit of image generation apparatus 505 (such as the processor unit 1905 described with reference to FIG. 19). In some embodiments, optimization component 515 comprises a CNN.

A convolutional neural network (CNN) is a type of deep learning model that is designed to process structured grid-like data, such as images. A CNN comprises layers, including convolutional layers, pooling layers, and fully connected layers, which transform input data to extract relevant features while preserving spatial relationships.

The convolutional layers perform feature extraction. For example, the convolutional layers apply small filters, or kernels, to an input, scanning the input in a systematic way to detect edges, textures, and more complex patterns. The filters slide across the input, performing mathematical operations called convolutions, which capture spatial hierarchies within the data, to generate feature maps. The pooling layers reduce the spatial dimensions of the feature maps while retaining important information. This process, often performed using max pooling, helps to make the CNN more efficient by reducing computational complexity and preventing overfitting. Once feature extraction and dimensionality reduction are complete, the fully connected layers interpret the learned features and make final predictions.

Glyph image 520 and guidance prompt 525 are examples of, or include aspects of, the corresponding elements described with reference to FIGS. 1, 3, and 4. Synthetic image 555 is an example of, or includes aspects of, the corresponding element described with reference to FIGS. 1, 3, 4, and 6.

FIG. 6 shows an example 600 of the effects of losses on a synthetic image according to aspects of the present disclosure. The example shown includes first synthetic image 605, second synthetic image 610, third synthetic image 615, and fourth synthetic image 620. First synthetic image 605, second synthetic image 610, third synthetic image 615, and fourth synthetic image 620 are examples of, or include aspects of, the corresponding elements described with reference to FIGS. 1, 3-5, and 7-8.

Referring to FIG. 6, each of first synthetic image 605, second synthetic image 610, third synthetic image 615, and fourth synthetic image 620 are generated based on a glyph image depicting a Q and a text guidance prompt “Quetzalcoatlus northropi”. First synthetic image 605 is generated as described with reference to FIG. 5, but without using a perceptual loss, second synthetic image 610 is generated as described with reference to FIG. 5, but without using an SSIM loss, third synthetic image 615 is generated as described with reference to FIG. 5, but without using an MSE loss, and fourth synthetic image 620 is generated as described with reference to FIG. 5 using both an MSE loss and an SSIM loss.

As shown by the examples, first synthetic image 605 does not adhere to the “Q” structure of the glyph image, while fourth synthetic image 620 includes greater detail relating to the semantic concept of the guidance prompt than second synthetic image 610 and third synthetic image 615. Fourth synthetic image 620 also depicts a more Q-like structure than second synthetic image 610 and third synthetic image 615.

FIG. 7 shows an example 700 of the effects of weighting a perceptual loss according to aspects of the present disclosure. The example shown includes first glyph image 705, first synthetic image 710, second synthetic image 715, second glyph image 720, third synthetic image 725, fourth synthetic image 730, third glyph image 735, fifth synthetic image 740, and sixth synthetic image 745. First glyph image 705, second glyph image 720, and third glyph image 735 are examples of, or include aspects of, the corresponding element described with reference to FIGS. 1 and 3-5. First synthetic image 710, second synthetic image 715, third synthetic image 725, fourth synthetic image 730, fifth synthetic image 740, and sixth synthetic image 745 are examples of, or include aspects of, the corresponding elements described with reference to FIGS. 1, 3-6, and 8.

Referring to FIG. 7, first synthetic image 710, second synthetic image 715, third synthetic image 725, fourth synthetic image 730, fifth synthetic image 740, and sixth synthetic image 745 are examples of synthetic images generated based on first glyph image 705, second glyph image 720, and third glyph image 735, respectively, as described with reference to FIG. 5. In particular, first synthetic image 710, third synthetic image 725, and fifth synthetic image 740 are generated using a relatively low weight for the perceptual loss, and consequently show less detail from a semantic concept of a guidance prompt, while second synthetic image 715, fourth synthetic image 730, and sixth synthetic image 745 are generated using a relatively high weight for the perceptual loss, and consequently show more detail from the semantic concept of the guidance prompt.

FIG. 8 shows an example 800 of the effects of time step sampling according to aspects of the present disclosure. The example shown includes first synthetic image 805, second synthetic image 810, and third synthetic image 815. First synthetic image 805, second synthetic image 810, and third synthetic image 815 are examples of, or include aspects of, the corresponding elements described with reference to FIGS. 1 and 3-7.

Referring to FIG. 8, each of first synthetic image 805, second synthetic image 610, and third synthetic image 815 are generated based on a glyph image depicting a Q and a text guidance prompt “Quetzalcoatlus northropi”. First synthetic image 805 is generated as described with reference to FIG. 5 using uniform time step sampling, second synthetic image 810 is generated as described with reference to FIG. 5 using DreamTime timestep sampling, and third synthetic image 815 is generated as described with reference to FIG. 5 using a combination of DreamTime and random time step sampling.

As shown by the examples, second synthetic image 810 includes more detail from the semantic concept of the guidance prompt than first synthetic image 805, and third synthetic image 815 includes more detail from the semantic concept of the guidance prompt than second synthetic image 810.

FIG. 9 shows an example of a guided diffusion model 900 according to aspects of the present disclosure. In some examples, guided diffusion model 900 describes the operation and architecture of the image generation model 1915 described with reference to FIG. 19. In some examples, guided diffusion model 900 describes aspects of the image generation model 510 described with reference to FIG. 5.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Diffusion models work by iteratively adding noise to the data during a forward process and then learning to recover the data by denoising the data during a reverse process. For example, image encoder 915 encodes original image 905 (e.g., a glyph image 520 as described with reference to FIG. 5) from pixel space 910 and generates original image features 920 (e.g., a latent representation) in latent space 925.

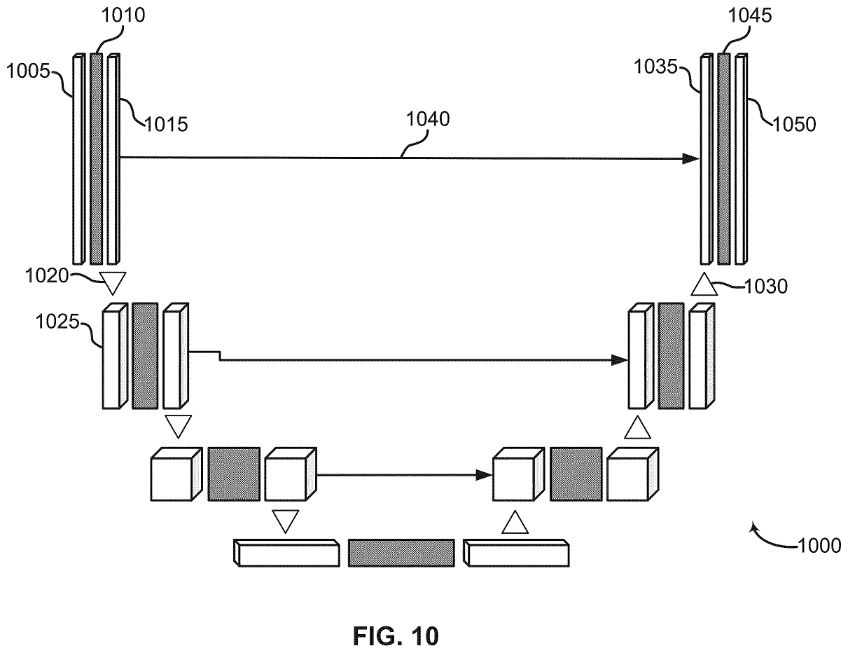

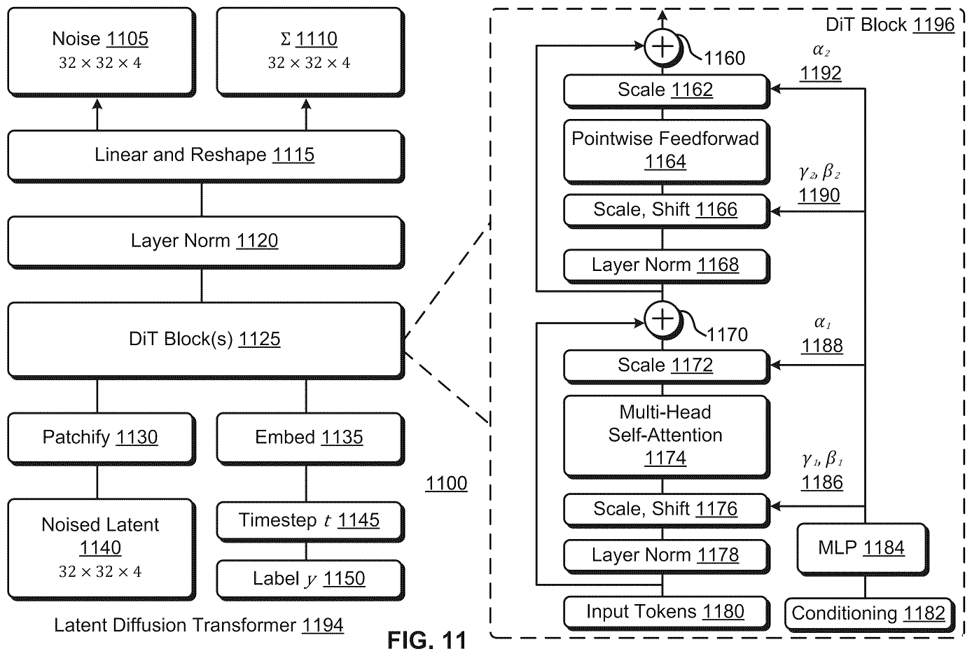

Guided diffusion model 900 applies forward diffusion process 930 to gradually add noise to the original image features 920 to obtain noisy features 935 (e.g., a latent code 530 as described with reference to FIG. 5) at various noise levels. Next, a reverse diffusion process 940 (e.g., a U-Net as described with reference to FIG. 10 or a diffusion transformer as described with reference to FIG. 11) predicts the added noise at various noise levels. While a comparative reverse diffusion process gradually removes the predicted noise from the noisy features 935 at the various noise levels to obtain denoised image features 945, in some embodiments, as described with reference to FIG. 5, the noisy features are optimized at the various noise levels to obtain the denoised image features 945 (e.g., an optimized latent code).

Then, decoder 950 decodes the denoised image features 945 from the latent space 925 to the pixel space 910 to obtain an output image 955. In some cases, an output image 955 is created from each of the various noise levels. The output image 955 can be compared to the original image 905 to train the reverse diffusion process 940.

The reverse diffusion process 940 can also be guided based on a guidance prompt 960, such as text, an image, a layout, a segmentation map, etc. (e.g., the guidance prompt 525 described with reference to FIG. 5). The guidance prompt 960 can be encoded using encoder 965 (e.g., a multimodal encoder) to obtain guidance features 970 in guidance space 975. In a comparative reverse diffusion process, the guidance features 970 can be combined with the noisy features 935 at one or more layers of the reverse diffusion process 940 to ensure that the output image 955 includes content described by the guidance prompt 960.

As described with reference to FIG. 5, according to some aspects, the guidance features 970 are used to determine a loss function for optimizing the noisy features 935 based on the predicted noise at the various noise levels. The decoder 950 decodes the optimized latent code (e.g., denoised image features 945) from the latent space 925 of the image generation model to obtain the output image 955 (e.g., the synthetic image 555 described with reference to FIG. 5) in the pixel space 910.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during image generation. Diffusion models may also be characterized by whether the noise is added to the image itself, or to image features generated by an encoder (i.e., latent diffusion). In a pixel diffusion model, noise is added and removed in pixel space. In a latent diffusion model, the noise is added (and removed) in a latent space of image features rather than in pixel space. Thus, a latent diffusion model generates image features using reverse diffusion, and these image features can be decoded to obtain a synthetic image.

FIG. 10 shows an example of a U-Net 1000 according to aspects of the present disclosure. In some examples, U-Net 1000 is an example of the component that performs the reverse diffusion process 940 of guided diffusion model 900 described with reference to FIG. 9 and includes architectural elements of the image generation model 1915 described with reference to FIG. 19. The U-Net 1000 depicted in FIG. 10 is an example of, or includes aspects of, the architecture used within the reverse diffusion process described with reference to FIG. 14.

In some examples, diffusion models are based on a neural network architecture known as a U-Net. The U-Net 1000 takes input features 1005 having an initial resolution and an initial number of channels and processes the input features 1005 using an initial neural network layer 1010 (e.g., a convolutional network layer) to produce intermediate features 1015. The intermediate features 1015 are then down-sampled using a down-sampling layer 1020 such that down-sampled features 1025 features have a resolution less than the initial resolution and a number of channels greater than the initial number of channels.

This process is repeated multiple times, and then the process is reversed. That is, the down-sampled features 1025 are up-sampled using up-sampling process 1030 to obtain up-sampled features 1035. The up-sampled features 1035 can be combined with intermediate features 1015 having a same resolution and number of channels via a skip connection 1040. These inputs are processed using a final neural network layer 1045 to produce output features 1050. In some cases, the output features 1050 have the same resolution as the initial resolution and the same number of channels as the initial number of channels.

In some cases, U-Net 1000 takes additional input features to produce conditionally generated output. For example, the additional input features could include a vector representation of an input prompt. The additional input features can be combined with the intermediate features 1015 within the neural network at one or more layers. For example, a cross-attention module can be used to combine the additional input features and the intermediate features 1015.

FIG. 11 shows an example of a diffusion transformer (DiT) architecture 1100 according to aspects of the present disclosure. In some examples, DiT architecture 1100 is an example of the component that performs the reverse diffusion process 940 of guided diffusion model 900 described with reference to FIG. 9 and includes architectural elements of the image generation model 1915 described with reference to FIG. 19. The DiT architecture 1100 depicted in FIG. 11 is an example of, or includes aspects of, the architecture used within the reverse diffusion process described with reference to FIG. 14.

The example shown includes predicted noise 1105, predicted covariance 1110, linear and reshape layers 1115, normalization layer 1120, DiT block(s) 1125, patchify operation 1130, embedding 1135, noised latent 1140, timestep information 1145, label information 1150, and an implementation of one block in the DiT blocks 1125 by a DiT block 1196.

The DiT block 1196 includes second residual connection 1160, second scaling operations 1162, feed-forward network 1164, post-normalization second scaling and shifting 1166, second normalization 1168, first residual connection 1170, first scaling operations 1172, self-attention 1174, post-normalization first scaling and shifting 1176, first normalization 1178, input tokens 1180, conditioning tokens 1182, multi-layer perceptron (MLP) 1184, post-normalization first scaling and shifting parameters 1186, first scaling parameter 1188, post-normalization second scaling and shifting parameters 1190, and second scaling parameter 1192. In some embodiments, the architecture employes a latent diffusion transformer 1194. In some embodiments, DiT block 1196 employs an “adaLN-Zero” technique.

A diffusion transformer (DiT) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a vision transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)\hat{ }2, where I is another shape parameter. Thus, halving p will quadruple T, which in some cases at least quadruples a total of transformer giga floating point operations (Gflops). In some examples, changing p has no impact on downstream parameter counts. I.e., parameter counts in downstream layers of DiT may be independent from p. In some examples, p=2,4 or 8. Various patch sizes, transformer block architectures, and model sizes are implemented.

Following the patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN, the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks that leverage zero-initialization techniques. In Residual Networks (ResNets), initializing each residual block as the identity function x→x is beneficial. In some examples, zero-initializing a final batch norm scale factor in each block accelerates large-scale training in supervised learning settings. Diffusion models based on U-Nets use a similar initialization strategy, zero-initializing a final convolutional layer in each block prior to residual connections.

An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all a; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, small (S), base (B), large (L), and extra large (XL) variants of model sizes are implemented. Small or base model sizes have N=12 layers of DiT blocks, large model sizes have 24 layers of DiT blocks, and extra large model sizes have 28 layers of DiT blocks.

After a final DiT block, the DiT network decodes the sequence of image tokens into an output noise prediction and an output diagonal covariance prediction. Both outputs have a shape equal to an original spatial input. A standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

In some embodiments, the DiT architecture 1100 employs a latent diffusion transformer 1194. The DiT architecture 1100 processes a noised latent 1140, which may be a noised version of an input image encoded in a latent space. The patchify operation 1130 divides the noised latent into a sequence of patches that are processed as tokens. The tokens are vector representations of each patch of the image in latent space and are adjusted through attention processes. Each of the tokens also receives timestep information 1145 and label information 1150 and, accordingly, their embedding 1135, which encodes the current denoising timestep and class labels as conditional information.

In some cases, embedding 1135 is referred to as a conditional embedding or a conditional information embedding. In some cases, a positional embedding that encodes a spatial position in the image of each token is applied to the patchified input tokens at the patchify operation 1130. In some examples, the positional embedding is a ViT frequency-based positional embedding. The input tokens 1180 generated by the patchify operation 1130 and the conditioning tokens 1182 generated by the embedding 1135 are processed through N DiT blocks 1125, where N may be 12, 24, or 28. Other values of N may be used. In some cases, a conditional token refers to a token generated based on embedding 1135 encoding timestep information 1145 and label information 1150.

Each of the DiT blocks 1125 includes multiple processing stages. DiT block 1196 illustrates an embodiment of one block in the DiT blocks 1125. In some embodiments, the DiT block 1196 is an example of, or includes aspects of, the adaLN-Zero block. In some cases, input tokens 1180 interact with the conditioning tokens 1182 through multiple attention mechanisms. Particularly, after first normalization 1178 is applied to the input tokens and MLP 1184 is applied to the conditional tokens, MLP 1184 generates or updates post-normalization first scaling and shifting parameters 1186, denoted as γ_1,β_1, for post-normalization first scaling and shifting 1176 to scale and shift the output of first normalization 1178 accordingly.

As the normalized input tokens obtained from first normalization 1178 are scaled and shifted at post-normalization first scaling and shifting 1176 using the conditional information carried as least in γ_1,β_1, this allows the input information and conditional information to interact. Self-attention 1174 allows the scaled and shifted normalized input tokens, namely the output from post-normalization first scaling and shifting 1176, to attend to each other. MLP 1184 also generates or updates first scaling parameter 1188, denoted as α_1, for first scaling operations 1172 to scale the output of self-attention 1174 (e.g., multi-head self-attention), further causing the input information and conditional information to interact. The input tokens 1180 are then summed with the output of first scaling operations 1172 at first residual connection 1170. In some examples, α_1 has initial values 0, and the DiT block 1196 is initialized as the identity function.

A similar process is performed in a second half of the DiT block 1196. MLP 1184 generates or updates post-normalization second scaling and shifting parameters 1190, denoted as γ_2,β_2, for post-normalization second scaling and shifting 1166 to scale and shift the output of second normalization 1168 accordingly. As the output from second normalization 1168 is scaled and shifted using the conditional information carried at least in γ_2,β_2, this allows the input information and conditional information to further interact.

Feed-forward network 1164 then processes the scaled and shifted output from post-normalization second scaling and shifting 1166. MLP 1184 also generates or updates second scaling parameter 1192, denoted as α_2, for second scaling operations 1162 to scale the output of feed-forward network 1164, further causing the input information and conditional information to interact. In some cases, the feed-forward network 1164 is a pointwise feed-forward network. The output from first residual connection 1170 is then summed with the output of second scaling operations 1162 at second residual connection 1160, and the result is the final output of DiT block 1196. In some examples, α_2 has initial values 0, and the DiT block 1196 is initialized as the identity function. This process repeats for each DiT block in the sequence.

After processing through all DiT blocks 1125, the outputs undergo normalization layer 1120 followed by linear and reshape layers 1115. The final output is the predicted noise 1105, which represents the model's prediction of the noise that was added to initially create the noised latent 1140, and the predicted covariance 1110, which represents the model's prediction of the covariance. The predicted noise 1105 is removed from noised latent 1140 at each diffusion timestep, and the predicted covariance may affect how noise is removed or resampled in the reverse or denoising process. At the end of the denoising schedule, the latent sample is decoded to generate the synthetic image in pixel space.

### Image Generation

FIG. 12 shows an example of a method 1200 for generating a synthetic image depicting a target structure and a target semantic concept using an optimized latent code according to aspects of the present disclosure. Referring to FIG. 12, an image generation apparatus (such as the image generation apparatus 1900 described with reference to FIG. 19) performs method 1200 to generate a synthetic image. In an example, the image generation apparatus optimizes a preliminary latent code for a glyph image based on a loss function derived from a guidance prompt and generates the synthetic image using the optimized latent code. By optimizing the preliminary latent code using the loss function, the synthetic image is able to accurately depict the target structure and target semantic concept.

At operation 1205, the system obtains a glyph image and a guidance prompt, where the glyph image depicts a target structure and the guidance prompt indicates a target semantic concept. In some cases, the operations of this step refer to, or may be performed by, an image generation apparatus as described with reference to FIGS. 1, 5, 18, and 19. In an example, a user provides the glyph image and the guidance prompt to the image generation apparatus via a user interface displayed by the image generation apparatus on a user device as described with reference to FIG. 1. The glyph image may depict a glyph having a structure, and the guidance prompt may be an image depicting the semantic concept or a text prompt describing the semantic concept. The structure is the target structure, and the semantic concept is the target semantic concept.

At operation 1210, the system generates a preliminary latent code based on the glyph image, where the latent code represents the target structure. In some cases, the operations of this step refer to, or may be performed by, an image generation model as described with reference to FIGS. 1, 5, 9-11, and 19. In an example, an encoder of the image generation model generates a latent representation of the glyph image in a latent space of the image generation model as described with reference to FIGS. 5 and 9 and adds noise to the latent representation using a forward diffusion process as described with reference to FIGS. 5 and 9 to obtain the latent code.

At operation 1215, the system optimizes the preliminary latent code based on the guidance prompt using a denoising loss and a perceptual loss to obtain an optimized latent code, where the optimized latent code represents the target structure and the target semantic concept. In some cases, the operations of this step refer to, or may be performed by, an optimization component as described with reference to FIG. 5. In an example, an encoder of the image generation model generates a representation of the guidance prompt in a guidance space as described with reference to FIG. 9. The image generation model predicts noise that has been added to the latent representation to obtain the latent code at varying noise levels as described with reference to FIGS. 5 and 9.

The optimization component determines the denoising loss based on the guidance features and predicted noise as described with reference to FIG. 5 and determines the perceptual loss as described with reference to FIG. 5. In some embodiments, the optimization component obtains a control parameter for weighting the perceptual loss (e.g., from a user) as described with reference to FIG. 5. In some embodiments, optimizing the preliminary latent code includes performing time-prioritized sampling with random time steps as described with reference to FIG. 5. The latent code is updated via the denoising loss and the perceptual loss until the image generation model predicts that the latent code does not include added noise, thereby obtaining the optimized latent code.

At operation 1220, the system generates, using an image generation model, a synthetic image based on the optimized latent code, where the synthetic image depicts the target structure and the target semantic concept. In some cases, the operations of this step refer to, or may be performed by, an image generation model as described with reference to FIGS. 1, 5, 9-11, and 19. In an example, the image generation model decodes the optimized latent code from the latent space to the pixel space to obtain the synthetic image, as described with reference to FIGS. 5 and 9.

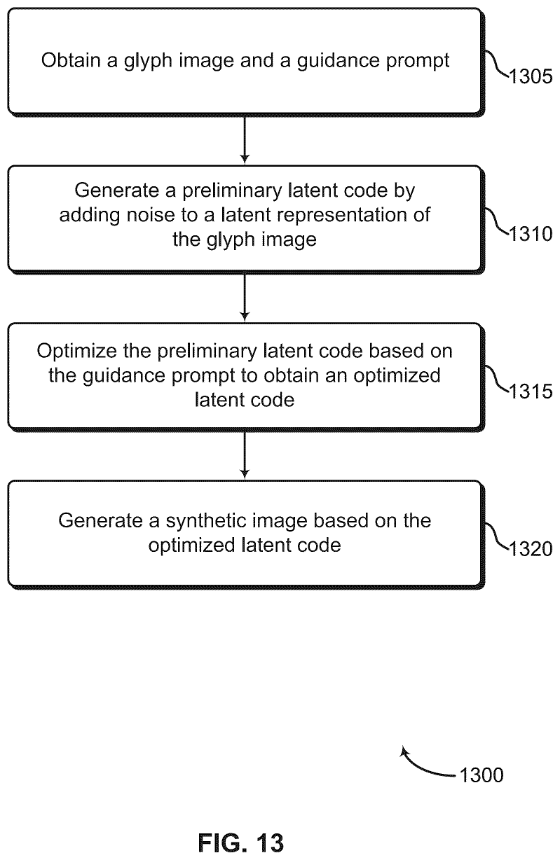

FIG. 13 shows an example of a method 1300 for generating a synthetic image based on a latent representation of a glyph image according to aspects of the present disclosure. At operation 1305, the system obtains a glyph image and a guidance prompt. In some cases, the operations of this step refer to, or may be performed by, an image generation apparatus as described with reference to FIGS. 1, 5, 18, and 19.

At operation 1310, the system generates a latent code by adding noise to a latent representation of the glyph image. In some cases, the operations of this step refer to, or may be performed by, an image generation model as described with reference to FIGS. 1, 5, 9-11, and 19.

At operation 1315, the system optimizes the latent code (e.g., a preliminary version of the latent code) based on the guidance prompt using a denoising loss and/or a perceptual loss to obtain an optimized latent code. In some cases, the operations of this step refer to, or may be performed by, an optimization component as described with reference to FIG. 5.

At operation 1320, the system generates, using an image generation model, a synthetic image based on the optimized latent code. In some cases, the operations of this step refer to, or may be performed by, an image generation model as described with reference to FIGS. 1, 5, 9-11, and 19.

FIG. 14 shows an example of a diffusion process 1400 according to aspects of the present disclosure. In some examples, diffusion process 1400 describes an operation of the image generation model 1915 described with reference to FIG. 19. As described above with reference to FIG. 9, using a diffusion model can involve both a forward diffusion process 1405 for adding noise to an image (or features in a latent space) and a reverse diffusion process 1410 for denoising the images (or features) to obtain a denoised image. The forward diffusion process 1405 can be represented as q(xₜ|xₜ₋₁), and the reverse diffusion process 1410 can be represented as p(xₜ₋₁|xₜ). In some cases, the forward diffusion process 1405 is used during training to generate images with successively greater noise, and a neural network is trained to perform the reverse diffusion process 1410 (i.e., to successively remove the noise).

In an example forward process for a latent diffusion model, the model maps an observed variable x₀ (either in a pixel space or a latent space) intermediate variables x₁, . . . , X_{T} using a Markov chain. The Markov chain gradually adds Gaussian noise to the data to obtain the approximate posterior q(x_{1:T}|x₀) as the latent variables are passed through a neural network such as a U-Net, where x₁, . . . , X_{T} have the same dimensionality as x₀.

The neural network may be trained to perform the reverse process. During the reverse diffusion process 1410, the model begins with noisy data x_{T}, such as a noisy image 1415, and denoises the data to obtain the p(xₜ₋₁|xₜ). At each step t−1, the reverse diffusion process 1410 takes xₜ, such as first intermediate image 1420, and t as input. Here, t represents a step in the sequence of transitions associated with different noise levels, The reverse diffusion process 1410 outputs xₜ₋₁, such as second intermediate image 1425 iteratively until x_{T} reverts back to x₀, the original image 1430. The reverse process can be represented as:

p_{θ}(xₜ₋₁|xₜ):=N(xₜ₋₁;μ_{θ}(xₜ,t),Σ_{θ}(xₜ,t)). (8)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 9 )$$

where P(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

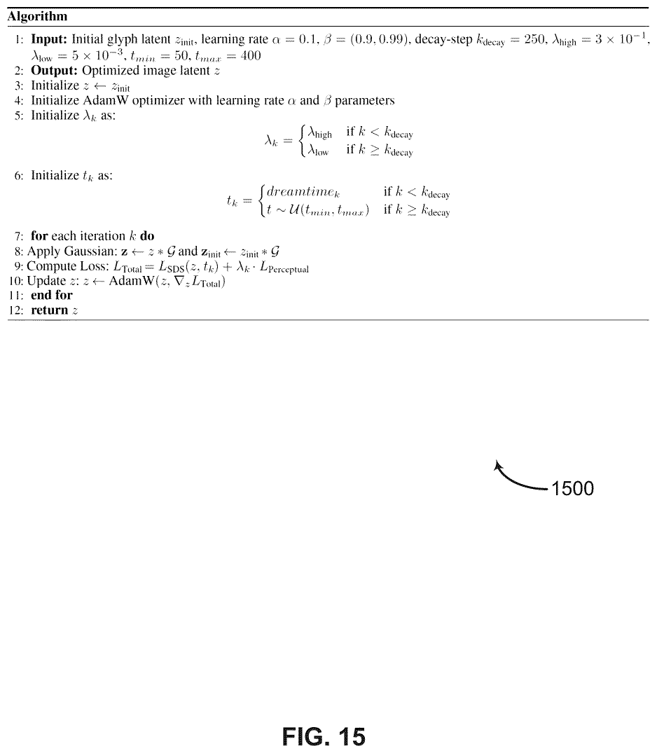

FIG. 15 shows an example of an algorithm 1500 for generating a synthetic image according to aspects of the present disclosure. Algorithm 1500 describes an example process for generating a synthetic image as described with reference to FIG. 5. zᵢₙᵢₜ denotes the initial latent representation of the glyph image and z denotes the latent representation of the current iteration. Applying the Gaussian blurrer [symbol] on zᵢₙᵢₜ and z helps to capture the low frequency features (such as structure and spatial similarity) between the latent representations.

According to some aspects, α and β are scale and shift parameters derived for the latent space of the image generation model by taking a set of randomly selected sample images and optimizing for α and β:

$${\hat{z}}^{rgb} = {z}_{latent}^{rgb} / α + β \qquad ( 10 )$$

$${L}_{1} = \frac{1}{N} {\sum }_{i = 1}^{N} \vert {z}_{i}^{rgb} - {\hat{z}}_{i}^{rgb} \vert$$

$${z}_{latent}^{rgb}$$

represents the tensor of the RGB-associated channels of a latent representation of an image. A corresponding ground-truth image is represented by

$${z}_{i}^{rgb} ,$$

and approximated image pixels generated by the image generation model are represented by

$${\hat{z}}_{i}^{rgb} .$$

Accordingly, a method for image generation is described. One or more aspects of the method include obtaining a glyph image and a guidance prompt, wherein the glyph image depicts a target structure and the guidance prompt indicates a target semantic concept; generating a preliminary latent code based on the glyph image, wherein the latent code represents the target structure; optimizing the preliminary latent code based on the guidance prompt using a denoising loss and a perceptual loss to obtain an optimized latent code, wherein the optimized latent code represents the target structure and the target semantic concept; and generating, using an image generation model, a synthetic image based on the optimized latent code, wherein the synthetic image depicts the target structure and the target semantic concept.

In some aspects, the perceptual loss is applied to a subset of channels of the latent code. In some aspects, the perceptual loss comprises a mean squared error loss, a structural similarity index loss, or a combination thereof. In some aspects, the denoising loss comprises a score distillation sampling loss. Some examples of the method further include obtaining a control parameter indicating a level of adherence to the target structure from the glyph image, wherein the perceptual loss is weighted based on the control parameter.

In some examples, generating the latent code includes generating a latent representation of the glyph image and adding noise to the latent representation to obtain the latent code. Some examples of the method further include performing time-prioritized sampling with random time steps.

Furthermore, a method for image generation is described. One or more aspects of the method include obtaining a glyph image and a guidance prompt; generating a preliminary latent code by adding noise to a latent representation of the glyph image; optimizing the preliminary latent code based on the guidance prompt using a denoising loss and a perceptual loss to obtain an optimized latent code; and generating, using an image generation model, a synthetic image based on the optimized latent code.

In some aspects, the glyph image depicts a target structure and the guidance prompt indicates a target semantic concept. In some aspects, the latent code represents the target structure. In some aspects, the optimized latent code represents the target structure and the target semantic concept. In some aspects, the synthetic image depicts the target structure and the target semantic concept. Some examples of the method further include performing time-prioritized sampling with random time steps.

In some aspects, the perceptual loss is applied to a subset of channels of the latent code. In some aspects, the perceptual loss comprises a mean squared error loss, a structural similarity index loss, or a combination thereof. In some aspects, the denoising loss comprises a score distillation sampling loss. Some examples of the method further include obtaining a control parameter indicating a level of adherence to the target structure from the glyph image, wherein the perceptual loss is weighted based on the control parameter.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

### Training

FIG. 16 shows an example of a training algorithm according to aspects of the present disclosure. shows an example of a flow diagram depicting an algorithm as a step-by-step procedure 1600 for training a machine learning model according to aspects of the present disclosure. In some embodiments, the procedure 1600 describes an operation of the training component 1925 described for configuring the image generation model 1915 described with reference to FIG. 19. The procedure 1600 provides one or more examples of generating training data, use of the training data to train a machine learning model, and use of the trained machine learning model to perform a task.

To begin in this example, a machine learning system collects training data (block 1602) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1604) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1606). Initialization of the machine learning model includes selecting a model architecture (block 1608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1610). The loss function is utilized to measure a difference between an output of the machine learning model (i.e., predictions) and target values (e.g., as expressed by the training data) to be used to train the machine learning model. Additionally, an optimization algorithm is selected (1612) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1614) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1618) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1620), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1620), the procedure 1600 continues training of the machine learning model using the training data (block 1618) in this example.

If the stopping criterion is met (“yes” from decision block 1620), the trained machine learning model is then utilized to generate an output based on subsequent data (block 1622). The trained machine learning model, for instance, is trained to perform a task as described above and therefore once trained is configured to perform that task based on subsequent data received as an input and processed by the machine learning model.

FIG. 17 shows an example of a method 1700 for training a diffusion model according to aspects of the present disclosure. In some embodiments, the method 1700 describes an operation of the training component 1925 described for configuring the image generation model 1915 described with reference to FIG. 19. The method 1700 represents an example for training a reverse diffusion process as described above with reference to FIG. 14. In some examples, these operations are performed by a system including a processor executing a set of codes to control functional elements of an apparatus.

Additionally or alternatively, certain processes of method 1700 may be performed using special-purpose hardware. Generally, these operations are performed according to the methods and processes described in accordance with aspects of the present disclosure. In some cases, the operations described herein are composed of various substeps or are performed in conjunction with other operations.

At operation 1705, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1710, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1715, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1720, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1725, the system updates parameters of the model based on the comparison. For example, parameters of a U-Net may be updated using gradient descent. Time-dependent parameters of the Gaussian transitions can also be learned.

### Image Generation Apparatus

FIG. 18 shows an example of a computing device according to aspects of the present disclosure. The computing device 1800 may be an example of the image generation apparatus described with reference to FIGS. 1, 5, and 19. In one aspect, computing device 1800 includes processor(s) 1805, memory subsystem 1810, communication interface 1815, I/O interface 1820, user interface components 1825, and channel 1830.

In some embodiments, computing device 1800 is an example of, or includes aspects of, the image generation model of FIG. 9. In some embodiments, computing device 1800 includes one or more processors 1805 that can execute instructions stored in memory subsystem 1810 to perform image generation.

According to some aspects, computing device 1800 includes one or more processors 1805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1815 operates at a boundary between communicating entities (such as computing device 1800, one or more user devices, a cloud, and one or more databases) and channel 1830 and can record and process communications. In some cases, communication interface 1815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1820 is controlled by an I/O controller to manage input and output signals for computing device 1800. In some cases, I/O interface 1820 manages peripherals not integrated into computing device 1800. In some cases, I/O interface 1820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1820 or via hardware components controlled by the I/O controller.

According to some aspects, user interface components 1825 enable a user to interact with computing device 1800. In some cases, user interface components 1825 include an audio device, such as an external speaker system, an external display device such as a display screen, an input device (e.g., a remote-control device interfaced with a user interface directly or through the I/O controller), or a combination thereof. In some cases, user interface components 1825 include a GUI.

FIG. 19 shows an example of an image generation apparatus 1900 according to aspects of the present disclosure. Image generation apparatus 1900 is an example of, or includes aspects of, the corresponding element described with reference to FIGS. 1, 5, and 18. Image generation apparatus 1900 may include an example of, or aspects of, the guided diffusion model described with reference to FIG. 9. In some embodiments, image generation apparatus 1900 includes processor unit 1905, memory unit 1910, image generation model 1915, I/O module 1920, and training component 1925. Training component 1925 updates parameters of the image generation model 1915 stored in memory unit 1910. In some examples, the training component 1925 is located outside the image generation apparatus 1900.

Processor unit 1905 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1905 is configured to operate a memory array using a memory controller. In other cases, a memory controller is integrated into processor unit 1905. In some cases, processor unit 1905 is configured to execute computer-readable instructions stored in memory unit 1910 to perform various functions. In some aspects, processor unit 1905 includes special purpose components for modem processing, baseband processing, digital signal processing, or transmission processing. According to some aspects, processor unit 1905 comprises one or more processors 1805 described with reference to FIG. 18.

Memory unit 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1905 to perform various functions described herein.

In some cases, memory unit 1910 includes a basic input/output system (BIOS) that controls basic hardware or software operations, such as an interaction with peripheral components or devices. In some cases, memory unit 1910 includes a memory controller that operates memory cells of memory unit 1910. For example, the memory controller may include a row decoder, column decoder, or both. In some cases, memory cells within memory unit 1910 store information in the form of a logical state. According to some aspects, memory unit 1910 is an example of the memory subsystem 1810 described with reference to FIG. 18.

According to some aspects, image generation apparatus 1900 uses one or more processors of processor unit 1905 to execute instructions stored in memory unit 1910 to perform functions described herein. For example, the image generation apparatus 1900 may perform operation comprising obtaining a glyph image and a guidance prompt, wherein the glyph image depicts a target structure and the guidance prompt indicates a target semantic concept; generating a preliminary latent code based on the glyph image, wherein the latent code represents the target structure; optimizing the preliminary latent code based on the guidance prompt using a denoising loss and a perceptual loss to obtain an optimized latent code, wherein the optimized latent code represents the target structure and the target semantic concept; and generating, using image generation model 1915, a synthetic image based on the optimized latent code, wherein the synthetic image depicts the target structure and the target semantic concept.

The memory unit 1910 may include an image generation model 1915 trained to generate a synthetic image based on the optimized latent code. For example, after training, the image generation model 1915 may perform inferencing operations as described with reference to FIGS. 12-15 to generate the synthetic image.

Image generation model 1915 is an example of, or includes aspects of, the image generation model described with reference to FIGS. 1, 5, and 9-11. In some embodiments, the image generation model 1915 is an artificial neural network (ANN) such as the guided diffusion model described with reference to FIG. 9. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the image generation model 1915 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1925 may train the image generation model 1915. For example, parameters of the image generation model 1915 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 16-17). The goal of the training process may be to find optimal values for the parameters that allow the image generation model 1915 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1915 can be used to make predictions on new, unseen data (i.e., during inference).

I/O module 1920 receives inputs from and transmits outputs of the image generation apparatus 1900 to other devices or users. For example, I/O module 1920 receives inputs for the image generation model 1915 and transmits outputs of the image generation model 1915. According to some aspects, I/O module 1920 is an example of the I/O interface 1820 described with reference to FIG. 18.

According to some aspects, training component 1925 comprises software stored in memory unit 1910 and executed by processor unit 1905, firmware, one or more hardware circuits, or a combination thereof.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application-specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image generation, comprising:
obtaining a glyph image and a guidance prompt, wherein the glyph image depicts a target structure and the guidance prompt indicates a target semantic concept;
generating a latent code based on the glyph image and the guidance prompt using a perceptual loss, wherein the latent code represents the target structure and the target semantic concept; and
generating, using an image generation model, a synthetic image based on the latent code, wherein the synthetic image depicts the target structure and the target semantic concept.

2. The method of claim 1, wherein generating the latent code comprises:
generating a preliminary latent code; and
optimizing the preliminary latent code based on the guidance prompt to obtain an optimized latent code, wherein the optimized latent code represents the target structure and the target semantic concept.

3. The method of claim 1, wherein:
the perceptual loss is applied to a subset of channels of the latent code.

4. The method of claim 1, wherein:
the latent code is based on a denoising loss.

5. The method of claim 1, wherein generating the latent code comprises:
generating a latent representation of the glyph image; and
adding noise to the latent representation.

6. The method of claim 1, further comprising:
obtaining a control parameter indicating a level of adherence to the target structure from the glyph image, wherein the perceptual loss is weighted based on the control parameter.

7. The method of claim 1, further comprising:
performing time-prioritized sampling with random time steps to optimize the latent code.

8. A non-transitory computer readable medium storing code for image generation, the code comprising instructions that, when executed by at least one processor, cause the at least one processor to perform operations comprising:
obtaining a glyph image and a guidance prompt;
generating a preliminary latent code by adding noise to a latent representation of the glyph image;
optimizing the preliminary latent code based on the guidance prompt using a denoising loss to obtain an optimized latent code; and
generating, using an image generation model, a synthetic image based on the optimized latent code.

9. The non-transitory computer readable medium of claim 8, wherein:
the glyph image depicts a target structure and the guidance prompt indicates a target semantic concept;
the preliminary latent code represents the target structure;
the optimized latent code represents the target structure and the target semantic concept; and
the synthetic image depicts the target structure and the target semantic concept.

10. The non-transitory computer readable medium of claim 9, the code further comprising instructions that, when executed by the at least one processor, cause the at least one processor to perform operations comprising:
obtaining a control parameter indicating a level of adherence to the target structure from the glyph image.

11. The non-transitory computer readable medium of claim 8, wherein:
the preliminary latent code is optimized using a perceptual loss applied to a subset of channels of the latent code.

12. The non-transitory computer readable medium of claim 8, wherein:
the preliminary latent code is optimized using a perceptual loss comprising a mean squared error loss, a structural similarity index loss, or a combination thereof.

13. The non-transitory computer readable medium of claim 8, wherein:
the denoising loss comprises a score distillation sampling loss.

14. The non-transitory computer readable medium of claim 8, the code further comprising instructions that, when executed by the at least one processor, cause the at least one processor to perform operations comprising:
performing time-prioritized sampling with random time steps.

15. A system comprising:
a memory component; and
a processing device coupled to the memory component, the processing device configured to perform operations comprising:
obtaining a glyph image and a guidance prompt, wherein the glyph image depicts a target structure and the guidance prompt indicates a target semantic concept;
generating a latent code based on the glyph image and the guidance prompt using a perceptual loss, wherein the latent code represents the target structure and the target semantic concept; and
generating, using an image generation model, a synthetic image based on the latent code, wherein the synthetic image depicts the target structure and the target semantic concept.

16. The system of claim 15, wherein:
the perceptual loss is applied to a subset of channels of the latent code.

17. The system of claim 15, wherein:
the latent code is based on a denoising loss.

18. The system of claim 17, wherein:
the denoising loss comprises a score distillation sampling loss.

19. The system of claim 15, wherein generating the latent code comprises:
generating a latent representation of the glyph image; and
adding noise to the latent representation to obtain a preliminary latent code.

20. The system of claim 15, the processing device being further configured to perform operations comprising:
obtaining a control parameter indicating a level of adherence to the target structure from the glyph image, wherein the perceptual loss is weighted based on the control parameter.
